(19) United States
(12) Patent Application Publication
(10) Pub. No.: US 2023/0093769 A1
(43) Pub. Date: Mar. 23, 2023

(54) MAGNETIC DISK DEVICE

(71) Applicants: Kabushiki Kaisha Toshiba, Tokyo (JP); Toshiba Electronic Devices & Storage Corporation, Tokyo (JP)

(72) Inventor: Shoichi Aoki, Yokohama Kanagawa (JP)

(21) Appl. No.: 17/680,065

(22) Filed: Feb. 24, 2022

(30) Foreign Application Priority Data
Sep. 22, 2021 (JP) 2021-154645

(51) Int. Cl. G06F 3/06; G06F 12/0868; G11B 5/012

(52) U.S. Cl. CPC G06F 3/0676; G06F 3/0656; G06F 12/0868; G11B 5/012; G06F 2212/281

(57) ABSTRACT

According to one embodiment, a magnetic disk device includes a first magnetic disk comprising a first recording surface accessed by using a first actuator system and second magnetic disk comprising a second recording surface accessed by using a second actuator system. The first recording surface includes a first area to which a logical address is mapped and a cache area. The second recording surface includes a second area to which a logical address is mapped and a cache area. When receiving first data whose final write destination is the first recording surface from a host, the controller writes the first data to a buffer memory. When the first event occurs, after the first data has been written to the buffer memory and before the first data has been written to the final write destination, the controller writes the first data in the buffer memory to the second area.

### CROSS-REFERENCE TO RELATED APPLICATION

This application is based upon and claims the benefit of priority from Japanese Patent Application No. 2021-154645, filed Sep. 22, 2021, the entire contents of which are incorporated herein by reference.

### FIELD

Embodiments described herein relate generally to a magnetic disk device.

### BACKGROUND

A magnetic disk device writes the data received from a host as a pair with a logical address value to a buffer memory. Thereafter, the magnetic disk device writes the data in the buffer memory to the position on the recording surface of a magnetic disk associated with the logical address value.

An area for saving data is provided on the recording surface of the magnetic disk. The area is referred to as a media cache area, or a cache area. For example, when the power supply to the magnetic disk device is cut off, the magnetic disk device writes all the data that has not yet been written to the magnetic disk in the buffer memory to the cache area. Then, when the power supply to the magnetic disk device is resumed, the magnetic disk device moves each data in the cache area to the position associated with the logical address value paired with each data.

In order to improve the response performance to the host, it is desired that the data transfer via the cache area provided in such a magnetic disk is completed as soon as possible.

In certain embodiments, a magnetic disk device is configured to be operable in response to a first event. The magnetic disk device comprises at least a first magnetic disk and at least a second magnetic disk. The first magnetic comprises a first recording surface, the first recording surface comprising a first area associated with logical address values of a first group. The second magnetic disk comprises a second recording surface, the second recording surface comprising a second area associated with logical address values of a second group. The second magnetic disk further comprises a cache area, separate from the second area.

The magnetic disk device further comprises a first magnetic head configured to perform data write and data read on the first recording surface of the first magnetic disk. The first magnetic head is configured to be moved by a first actuator system. The magnetic disk device further comprises a second magnetic head configured to perform data write and data read on the second recording surface of the second magnetic disk. The second magnetic head is configured to be moved by a second actuator system.

The magnetic disk device further comprises a buffer memory and a controller. The controller of the magnetic disk device is configured to write, to the buffer memory, first data for which there is specified a first logical address value. The first logical address value is a logical address value of the first group. The controller is further configured to write, after the first data is written to the buffer memory and in response to an occurrence of the first event, the first data in the buffer memory to the cache area of the second magnetic disk.

In further embodiments, after the controller writes the first data to the cache area of the second magnetic disk, the controller is further configured to execute first processing and second processing in parallel. In such embodiments, first processing comprises reading the first data from the cache area of the second magnetic disk, and second processing comprises writing the first data read from the cache area of the second magnetic disk to a position on the first area of the first recording surface that is associated with the specified first logical address value.

In certain embodiments, the first magnetic disk also comprises a cache area, and in such embodiments, the controller is further configured to write, to the buffer memory, second data for which there is specified a second logical address value. The second logical address value is a logical address value of the second group. The controller is further configured to write, after the second data is written to the buffer memory and in response to an occurrence of the first event, the second data in the buffer memory to the cache area of the first magnetic disk.

In further embodiments, after the controller writes the second data to the cache area of the first magnetic disk, the controller is further configured to execute third processing and fourth processing in parallel. In such embodiments, third processing comprises reading the second data from the cache area of the first magnetic disk, and fourth processing comprises writing the second data read from the cache area of the first magnetic disk to a position on the second area of the second recording surface that is associated with the specified second logical address value.

In some embodiments, when the first event occurs after a time at which the first data and the second data are written to the buffer memory, but before a time at which at least one of the writing the first data to the first area and writing the second data to the second area is executed, the controller is configured to both execute processing of writing the first data in the buffer memory to the cache area of the second magnetic disk by controlling the second magnetic head and the second actuator system and to execute processing of writing the second data in the buffer memory to the cache area of the first magnetic disk by controlling the first magnetic head and the first actuator system in parallel.

In certain embodiments, the magnetic disk device further comprises a circuit that monitors power supplied to the magnetic disk device. In such embodiments, an example of a first event is that the circuit detects an outage of the power. In some embodiments, the magnetic disk device further comprises a sensor that detects an impact. In such embodiments, an example of a first event is that the sensor detects the impact. In further embodiments, an example of a first event is that a flush command is received from the host, wherein the flush command instructs the controller to write data in the buffer memory to a magnetic disk.

In certain embodiments, a method of operating a magnetic disk device in response to a first event comprises receiving, from a host, first data having a first specified logical address value, the first specified logical address value being associated with a first group of logical address values. The first group of logical address values is associated with a first area of a first recording surface on a first magnetic disk of the magnetic disk device. In such embodiments, the method further comprises writing to a buffer memory the first data and in response to the first event, writing the first data in the buffer memory to a cache area associated with a second recording surface on a second magnetic disk. The second recording surface of the second magnetic disk further comprises a second area, separate from the cache area, associated with logical address values of a second group different from the first group.

In certain embodiments of the method of operating a magnetic disk device in response to a first event, the writing and reading of data on the first recording surface of the first magnetic disk is performed by a first magnetic head. The first magnetic head is configured to be moved by a first actuator system. In some embodiments, the writing and reading of data on the second recording surface is performed by a second magnetic head. The second magnetic head is configured to be moved by a second actuator system.

In some embodiments, the method of operating a magnetic disk device in response to a first event further comprises executing first processing and second processing in parallel. In such embodiments, first process comprises reading the first data from the cache area of the second magnetic disk, and second processing comprises writing the first data read from the cache area of the second magnetic disk to a position on the first area of the first recording surface that is associated with the first logical address value.

In certain embodiments, the method further comprises receiving, from the host, second data have a second specified logical address value. The second logical address value is associated with a second group of logical address values, and the second group of logical address values is associated with the second area of the second recording surface of the second magnetic disk. In some embodiments, the method further comprises writing the second data to the buffer memory. In certain embodiments, in response to the first event, the method further comprises writing the second data in the buffer memory to a second cache area associated with the first recording surface of the first magnetic disk. In such embodiments, the second cache area is separate from the first area of the first recording surface of the first magnetic disk.

In some embodiments, the method further comprises executing third processing and further processing in parallel. In such embodiments, third processing comprises reading the second data from the cache area of the first magnetic disk, and fourth processing comprises writing the second data read from the cache area of the first magnetic disk to a position on the second area of the second recording surface that is associated with the second logical address value.

In certain embodiments, when the first event occurs between a time at which the first data and the second data are written to the buffer memory and a time at which at least one of writing the first data to the first area and writing the second data to the second area is executed, the method of operating a magnetic disk device in response to a first event further comprises executing, in parallel, processing of writing the first data in the buffer memory to the cache area of the second magnetic disk and processing of writing the second data in the buffer memory to the cache area of the first magnetic disk. In such embodiments, the processing of writing the first data in the buffer memory to the cache area of the second magnetic disk is performed by controlling the second magnetic head and the second actuator system, and the processing of writing the second data in the buffer memory to the cache area of the first magnetic disk is performed by controlling the first magnetic head and the first actuator system.

Examples of related art include U.S. Pat. No. 7,800,856, Japanese Unexamined Patent Publication No. 11-232037, and U.S. Patent Application Publication No. 2021/0004327.

### DESCRIPTION OF THE DRAWINGS

FIG. 1 is a diagram illustrating an example of a configuration of a magnetic disk device according to an embodiment.

FIG. 2 is a schematic diagram illustrating an example of a configuration of one magnetic disk of the embodiment.

FIG. 3 is a schematic diagram illustrating an area allocated to one recording surface of one magnetic disk of the embodiment.

FIG. 4 is a schematic diagram illustrating an area allocated to a volatile memory of the embodiment.

FIG. 5 is a schematic diagram illustrating a save operation of the embodiment.

FIG. 6 is a schematic diagram illustrating an operation of the embodiment in which data saved in a media cache area is moved to a logical address area.

FIG. 7 is a flowchart illustrating an example of an operation at the time of receiving data of the magnetic disk device of the embodiment.

FIG. 8 is a flowchart illustrating an example of an operation of the magnetic disk device of the embodiment in which data in a buffer memory area is written to the magnetic disk.

FIG. 9 is a flowchart illustrating an example of an operation of the magnetic disk device when the power supply from a power source is resumed.

### DETAILED DESCRIPTION

Embodiments provide a magnetic disk device capable of reducing the time required to transfer data via a media cache area.

In general, according to one embodiment, a magnetic disk device can be connected to a host. The magnetic disk device includes at least a first magnetic disk and a second magnetic disk, at least a first magnetic head and a second magnetic head, at least a first actuator system a second actuator system, a buffer memory, and a controller. The first magnetic disk includes a first recording surface. The first recording surface includes a first area associated with logical address values of a first group, and an area, separate from the first area, used as a cache area The second magnetic disk includes a second recording surface. The second recording surface includes a second area associated with logical address values of a second group different from the logical address values of the first group, and an area used as cache area. The first magnetic head writes data and reads data with respect to the first recording surface. The second magnetic head writes data and reads data with respect to the second recording surface. The first actuator system moves the first magnetic head. The second actuator system moves the second magnetic head.

When the controller receives first data for which a first logical address value included in the first group is specified from the host, the controller writes the first data to the buffer memory. When a first event does not occur after the first data is written to the buffer memory, the controller writes the first data in the buffer memory to the position in the first area associated with the first logical address value by controlling the first magnetic head and the first actuator system. When the first event occurs from when the first data is written to the buffer memory to when the first data is written to the first area, the controller writes the first data in the buffer memory to the cache area of the second recording surface by controlling the second magnetic head and the second actuator system.

The magnetic disk device according to the embodiment will be described in detail with reference to the accompanying drawings. The present disclosure is not limited to this embodiment.

### Embodiment

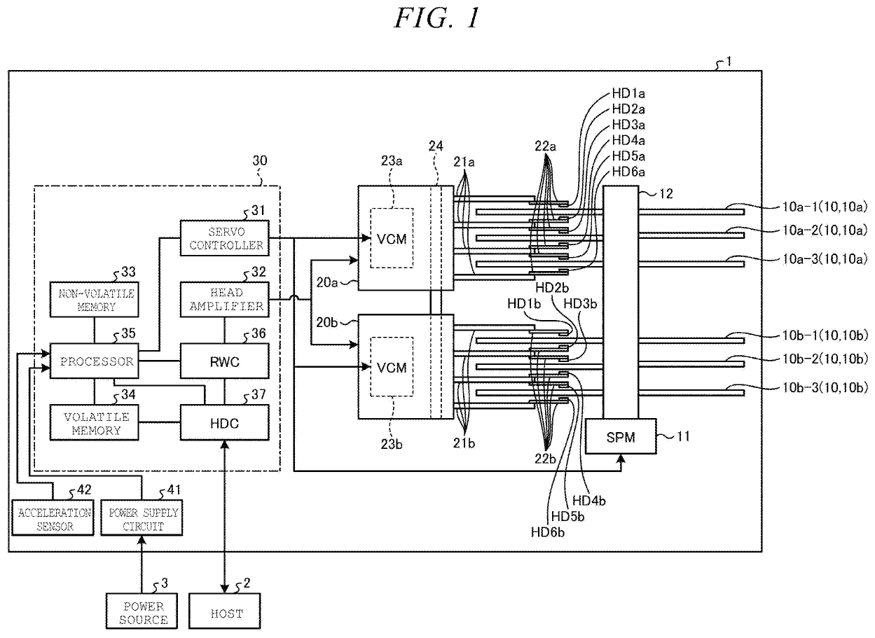

FIG. 1 is a diagram illustrating an example of a configuration of a magnetic disk device 1 according to the embodiment. The magnetic disk device 1 can be connected to a host 2. The standard of the communication path between the magnetic disk device 1 and the host 2 is not limited to a specific standard. In one example, serial attached SCSI (SAS) may be adopted.

The host 2 corresponds to, for example, a processor, a personal computer, a server, or the like. The magnetic disk device 1 can receive access commands (read commands and write commands) from the host 2.

An access command includes a logical address value. The magnetic disk device 1 provides the host 2 with a logical address space. A logical address is information indicating a position in the logical address space. The host 2 specifies a position to write data to or a position from which to read data by using a logical address.

For example, when writing data to the magnetic disk device 1, the host 2 transmits a write command including a logical address value for specifying a write position of the data to the magnetic disk device 1 together with the data. Therefore, the magnetic disk device 1 can receive, as a pair, both the data to be written and the logical address value indicating the write position of the data.

The magnetic disk device 1 includes a spindle motor (SPM) 11 and a plurality of magnetic disks 10 that rotate around a rotation shaft 12 of the spindle motor 11. Here, as an example, in the magnetic disk device 1, six magnetic disks 10a-1, 10a-2, 10a-3, 10b-1, 10b-2, and 10b-3 are integrally rotated by a SPM 310. Among the six magnetic disks 10, the magnetic disks 10a-1, 10a-2, and 10a-3 may be collectively referred to as a first magnetic disk 10a. Among the six magnetic disks 10, the magnetic disks 10b-1, 10b-2, and 10b-3 may be collectively referred to as a second magnetic disk 10b.

A recording surface on which data can be recorded is formed on the front surface and the back surface of the six magnetic disks 10. That is, the six magnetic disks 10 have twelve recording surfaces. In order to access each of the twelve recording surfaces, the magnetic disk device 1 includes twelve magnetic heads HD1a to HD6a and HD1b to HD6b corresponding to the twelve recording surfaces.

Here, as an example, the side opposite to the spindle motor 11 is referred to as a front surface. The side of the spindle motor 11 is referred to as a back surface. The definitions of the front surface and the back surface are not limited thereto.

The magnetic head HD1a faces the front surface of the magnetic disk 10a-1. The magnetic head HD2a faces the back surface of the magnetic disk 10a-1. The magnetic head HD3a faces the front surface of the magnetic disk 10a-2. The magnetic head HD4a faces the back surface of the magnetic disk 10a-2. The magnetic head HD5a faces the front surface of the magnetic disk 10a-3. The magnetic head HD6a faces the back surface of the magnetic disk 10a-3.

The magnetic head HD1b faces the front surface of the magnetic disk 10b-1. The magnetic head HD2b faces the back surface of the magnetic disk 10b-1. The magnetic head HD3b faces the front surface of the magnetic disk 10b-2. The magnetic head HD4b faces the back surface of the magnetic disk 10b-2. The magnetic head HD5b faces the front surface of the magnetic disk 10b-3. The magnetic head HD6b faces the back surface of the magnetic disk 10b-3.

Hereinafter, the twelve magnetic heads HD1a to HD6a and HD1b to HD6b may be collectively referred to as a magnetic head HD. The six magnetic heads HD1a to HD6a may be collectively referred to as a first magnetic head HDa. The six magnetic heads HD1b to HD6b may be collectively referred to as a second magnetic head HDb. Each magnetic head HD executes access, that is, writing of data and reading of data, on a recording surface provided on a front surface of the six magnetic disks 10 facing itself. That is, the first magnetic head HDa executes access to the recording surface of the first magnetic disk 10a. The second magnetic head HDb executes access to the recording surface of the second magnetic disk 10b.

Each recording surface of the first magnetic disk 10a is referred to as a first recording surface. Each recording surface of the second magnetic disk 10b is referred to as a second recording surface. The first recording surface is a recording surface accessed by using a first actuator system 20a and the first magnetic head HDa. The second recording surface is a recording surface accessed by using a second actuator system 20b and the second magnetic head HDb.

The magnetic disk device 1 includes two actuator systems 20a and 20b that can be driven individually. The first actuator system 20a includes four actuator arms 21a, six suspensions 22a, and a voice coil motor (VCM) 23a. Each of the six suspensions 22a supports any one of the magnetic heads HD1a to HD6a. Each of the six suspensions 22a is attached to the tip of any one of the four actuator arms 21a.

The second actuator system 20b includes four actuator arms 21b, six suspensions 22b, and a voice coil motor (VCM) 23b. Each of the six suspensions 22b supports any one of the magnetic heads HD1b to HD6b. Each of the six suspensions 22b is attached to the tip of any of the four actuator arms 21b.

The two actuator systems 20a and 20b can rotate around a rotation shaft 24. The rotation shaft 24 is provided at a position parallel to the rotation shaft 12 and separated from the rotation shaft 12. The voice coil motor 23a can rotate the first actuator system 20a within a predetermined range around the rotation shaft 24. The voice coil motor 23b rotates the second actuator system 20b within a predetermined range around the rotation shaft 24. Therefore, the first actuator system 20a moves the magnetic heads HD1a to HD6a relative to each recording surface (that is, the first recording surface) of the magnetic disks 10a-1 to 10a-3 in the radial direction. The second actuator system 20b moves the magnetic heads HD1b to HD6b relative to each recording surface (that is, the second recording surface) of the magnetic disks 10b-1 to 10b-3 in the radial direction.

The magnetic disk device 1 further includes a servo controller 31, a head amplifier 32, a non-volatile memory 33, a volatile memory 34, a processor 35, a read/write channel (RWC) 36, and a hard disk controller (HDC) 37.

The head amplifier 32 supplies a signal corresponding to the data input from the read/write channel 36 to the magnetic head HD facing the recording surface of a write destination. Further, the head amplifier 32 amplifies the signal output from the magnetic head HD facing the recording surface of the read source and supplies the signal to the read/write channel 36.

The non-volatile memory 33 is composed of a non-volatile memory such as a flash memory. The program executed by the processor 35 is recorded in the non-volatile memory 33.

The volatile memory 34 is composed of a volatile memory such as dynamic random access memory (DRAM) or static random access memory (SRAM). The volatile memory 34 functions as a buffer memory area, a cache memory area, an area in which a program is loaded, and the like. The function of the volatile memory 34 will be described later.

The read/write channel 36 modulates the data stored in the buffer memory area (here, for example, the volatile memory 34) and outputs the data to the head amplifier 32. Further, the read/write channel 36 demodulates the signal supplied from the head amplifier 32 and outputs the signal to the hard disk controller 37.

The hard disk controller 37 is a communication interface that enables communication with the host 2. Specifically, when the hard disk controller 37 receives a write command from the host 2, the hard disk controller 37 writes the data requested to be written by the write command to the buffer memory area. Further, when the hard disk controller 37 receives a read command from the host 2, the hard disk controller 37 transmits the data requested to be read by the read command to the host 2 via the buffer memory area.

Magnetic disk device 1 further comprises a controller 30, the controller comprising servo controller 31, head amplifier 32, non-volatile memory 33, volatile memory 34, processor 35, read/write channel 36, and hard disk controller 37. The servo controller 31 supplies power to the spindle motor 11 to integrally rotate the 12 magnetic disks 10 at a predetermined speed. Further, the servo controller 31 drives the voice coil motor 23a and the voice coil motor 23b to move the magnetic head HD to an access position (that is, a write destination track or a read source track) instructed by the processor 35.

The processor 35 is, for example, a central processing unit (CPU). The processor 35 executes various processing by a program stored in a non-volatile storage medium such as the non-volatile memory 33 or the magnetic disk 10.

For example, the processor 35 executes control of data write and data read by the magnetic head HD, processing of determining an access position on the recording surface of the magnetic disk 10, processing of instructing the servo controller 31 on the access position, and the like.

The servo controller 31, the head amplifier 32, the non-volatile memory 33, the volatile memory 34, the processor 35, the read/write channel 36, and the hard disk controller 37 constitute a controller 30 according to the embodiment. The components of the controller 30 are not limited thereto.

Some or all of the functions of the processor 35 may be implemented by other components in the controller 30 (for example, the servo controller 31, the head amplifier 32, the read/write channel 36, or the hard disk controller 37). Further, some or all of the functions of the processor 35 may be implemented by a hardware circuit such as field-programmable gate array (FPGA) or application specific integrated circuit (ASIC).

The magnetic disk device 1 further includes a power supply circuit 41 and an acceleration sensor 42.

The power supply circuit 41 generates power for driving each component provided in the magnetic disk device 1, and distributes the generated power to each component based on the power supplied from a power source 3 provided outside the magnetic disk device 1.

Further, the power supply circuit 41 detects an outage of power supply from the power source 3 (in other words, the power source is cut off). In one example, the power supply circuit 41 monitors the voltage of the power supply line connecting the power source 3 and itself. Then, when the voltage falls below a predetermined threshold value, the power supply circuit 41 determines that the power supply from the power source 3 has stopped. The method for detecting an outage of power supply from the power source 3 is not limited thereto. When detecting an outage of power supply from the power source 3, the power supply circuit 41 transmits an interrupt signal to the processor 35. The processor 35 recognizes an outage of power supply from the power source 3 by the interrupt signal from the power supply circuit 41, and executes processing according to the outage of the power supply from the power source 3. The power supply circuit 41 is an example of a circuit that monitors the power supplied to the magnetic disk device 1.

The acceleration sensor 42 detects an acceleration value. The acceleration value detected by the acceleration sensor 42 is sent to the processor 35. The processor 35 determines whether or not the magnetic disk device 1 has received an external impact or vibration based on the acceleration value detected by the acceleration sensor 42.

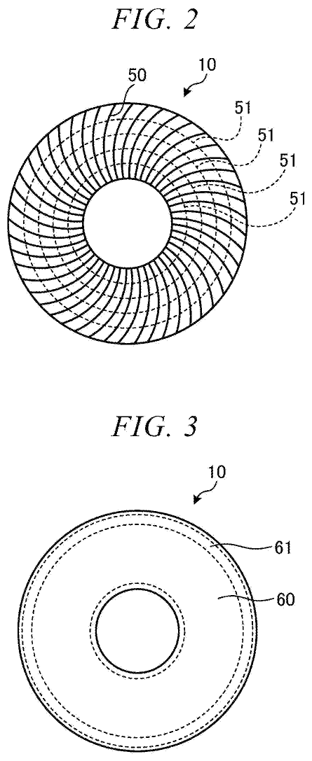

FIG. 2 is a schematic diagram illustrating an example of a configuration of one magnetic disk 10 of the embodiment. The six magnetic disks 10 have the same configuration. Servo information is written on the recording surface of the magnetic disk 10 by, for example, a servo writer before shipment. Servo information includes sector/cylinder information and burst patterns. The sector/cylinder information can give the servo addresses in the circumferential direction and the radial direction of the magnetic disk 10, and is used for seek control to move the magnetic head HD to a target track. The burst pattern is used for tracking control to keep the magnetic head HD on the target track. The servo information may be written on the magnetic disk 10 by the self-servo write (SSW) after shipment. FIG. 2 illustrates servo areas 50 arranged radially as an example of the arrangement of the servo areas in which servo information is written. A plurality of concentric tracks (for example, tracks 51 in this drawing) are set in the radial direction of the magnetic disk 10. A large number of sectors on which data is written are disposed on each track 51.

FIG. 3 is a schematic diagram illustrating an area allocated to one recording surface of one magnetic disk 10 of the embodiment. The twelve recording surfaces of each of the six magnetic disks 10 have the same configuration. A logical address area 60 and a cache area 61 are allocated on the recording surface of each magnetic disk 10. In the example illustrated in FIG. 3, the logical address area 60 is allocated on the inner circumferential side of the magnetic disk 10, and the media cache area 61 is allocated on the outer circumferential side of the magnetic disk 10. The positions where the areas 60 and 61 are allocated are not limited to this example.

The logical address area 60 is an area used as the final write destination of the data requested to be written by the host 2. A group of logical address values is mapped to the logical address area 60. More specifically, each sector provided in the logical address area 60 is associated with a different logical address value. The controller 30 writes the data requested to be written by the host 2 to the position in the logical address area 60 associated with the received logical address value paired with the data. That is, data whose write position is specified by a predetermined logical address value is written to each sector provided in the logical address area 60.

A group of different logical address values is mapped to the two logical address areas 60 provided on different recording surfaces of different magnetic disks. Therefore, the group of logical address values associated with the logical address area 60 on the first recording surface of a first magnetic disk is different from the group of logical address values associated with the logical address area 60 on the second recording surface of a second magnetic disk. The group of logical address values associated with the logical address area 60 on the first recording surface is an example of the logical address values of a first group. The group of logical address values associated with the logical address area 60 on the second recording surface is an example of the logical address values of a second group.

The cache area 61 is an area in which data is stored temporarily and in a non-volatile way. Any data can be written to each sector provided in the cache area 61. The controller 30 uses the cache area 61 as an area for temporarily saving data that has not yet been written to the final write position. A group of logical address values can also be mapped to the cache area 61. The group of logical address values mapped to the cache area 61 is different from, for example, the group of logical address values used by the host 2. The group of logical address values mapped to the cache area 61 is used by the controller 30. The controller 30 may use the group of logical address values mapped to the cache area 61 to specify the position of the data save destination in the cache area 61.

The logical address area 60 provided on the first recording surface of the first magnetic disk is an example of a first area. The cache area 61 provided on the first recording surface is a cache area that is separate from the first area. The logical address area 60 provided on the second recording surface of the second magnetic disk is an example of a second area. The cache area 61 provided on the second recording surface is separate from the second area.

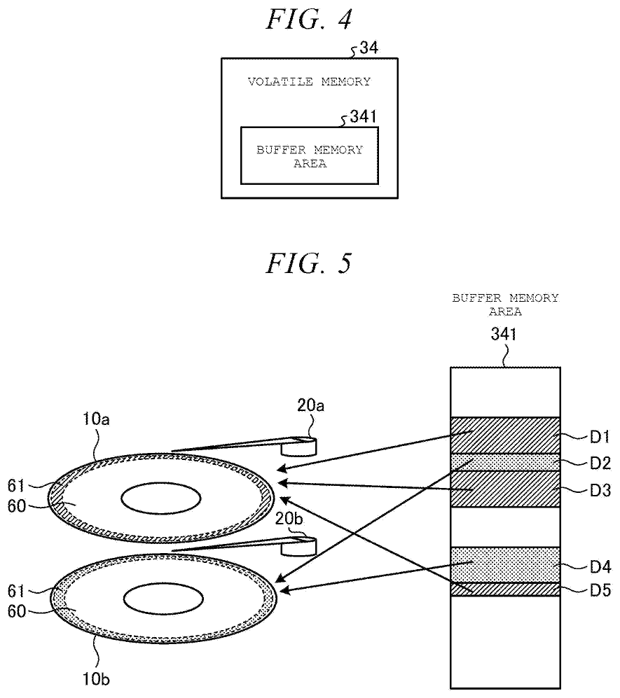

FIG. 4 is a schematic diagram illustrating the area allocated to the volatile memory 34 of the embodiment. In the example illustrated in this drawing, the buffer memory area 341 is allocated in the volatile memory 34. The buffer memory area 341 is an example of the buffer memory.

The buffer memory area 341 provides the controller 30 with a function as a buffer memory. Generally, the maximum speed of writing data to the magnetic disk 10 is slower than the maximum speed at which the hard disk controller 37 can receive data from the host 2. Therefore, the controller 30 writes the data requested to be written by the host 2 to the buffer memory area 341, and stores the data in the buffer memory area 341 until the writing of the data to the magnetic disk 10 (more specifically, the writing of the data to the logical address area 60 on any one of the recording surfaces) is completed. The buffer memory area 341 has a sufficient capacity to store a large amount of data requested to be written by different write commands. The controller 30 sequentially writes the data received from the host 2 to the buffer memory area 341, and sequentially writes the data in the buffer memory area 341 to the magnetic disk 10.

The buffer memory area 341 is allocated to the volatile memory 34. Therefore, when the power supply to the volatile memory 34 is interrupted, the data in the buffer memory area 341 is lost. On the other hand, the magnetic disk 10 can store data in a non-volatile way. Therefore, writing the data in the buffer memory area 341 to the magnetic disk 10 may be described as making the data non-volatile.

In addition to the data received from the host 2, any information may be stored in the volatile memory 34. For example, management information is stored in the volatile memory 34. In the management information, for example, the write position of one or more data stored in the buffer memory area 341, that is, the position in the logical address area 60 on any recording surface specified by the logical address value paired with each data, is recorded by the controller 30.

The volatile memory 34 may be composed of one memory or a plurality of memories. When the volatile memory 34 is composed of a plurality of memories, the area in which the management information is stored and the buffer memory area 341 may be allocated to different memories.

Subsequently, the operation of the magnetic disk device 1 of the embodiment will be described.

As described above, the controller 30 writes the data received from the host 2 to the magnetic disk 10 via the buffer memory area 341. Therefore, in the buffer memory area 341, there may be data that has not yet been written to the magnetic disk 10, that is, data that has not yet been made non-volatile. When a first event occurs in which data that has not yet been made non-volatile in the buffer memory area 341 is supposed to be quickly made non-volatile, the controller 30 saves the data in the cache area 61 instead of the logical address area 60. Hereinafter, unless otherwise specified, saving means writing the data in the buffer memory area 341 that has not yet been made non-volatile to the cache area 61.

When writing data to the logical address area 60, the data is written to the position specified by the logical address value in the logical address area 60. Therefore, for example, when writing a plurality of data whose specified logical address values are separated from each other to the logical address area 60, the controller 30 needs to execute seek control and tracking control for each data, and it takes a lot of time to write the plurality of data.

On the other hand, data can be written to any position in the media cache area 61 regardless of the specified logical address value. Therefore, the controller 30 can sequentially write the plurality of data to a continuous area in the cache area 61, even when the specified logical address values of each of the plurality of data are separated from each other. That is, when a plurality of data are written to the media cache area 61, the number of times of seek control execution can be remarkably reduced as compared with the case where a plurality of data are written to the logical address area 60. As a result, the time required to write the plurality of data to the cache area 61 is smaller than the time required to write the plurality of data to the logical address area 60.

When the first event occurs, the controller 30 saves the data that has not yet been made non-volatile in the buffer memory area 341 to the cache area 61, thereby reducing the time required for the save operation.

A designer may set any event as a first event. In certain embodiments, the first event is that an outage of power supply to the magnetic disk device 1 is detected. When detecting an outage of power supply to the magnetic disk device 1, the power supply circuit 41 transmits an interrupt signal to the processor 35. When the processor 35 receives an interrupt signal, the controller 30 executes a save operation in order to prevent data that has not yet been made non-volatile from being lost from the magnetic disk device 1, where, as stated saving means writing the data in the buffer memory area 341 that has not yet been made non-volatile to the cache area 61.

In another example, the first event is that the acceleration value detected by the acceleration sensor 42 indicates the application of impact or vibration exceeding a permissible level. When the processor 35 determines that the acceleration value detected by the acceleration sensor 42 indicates the application of impact or vibration exceeding the permissible level, the controller 30 executes a save operation.

In yet another example, the first event is that a flush command is received from host 2. The flush command is a command that requests that the data that has not yet been made non-volatile in the buffer memory area 341 be written to the magnetic disk 10. The controller 30 executes a save operation in response to a flush command.

In the following description, the first event will be described as, for example, that an outage of power supply to the magnetic disk device 1 is detected.

FIG. 5 is a schematic diagram illustrating the save operation of the embodiment. According to the example illustrated in this drawing, the buffer memory area 341 stores data D1 to D5 that have not yet been made non-volatile. Each of the hatched fill data D2 and D4 indicates data in which the logical address area 60 of the first magnetic disk 10a (more accurately, the logical address area 60 on the first recording surface) is the final write destination. Each of the diagonally hatched data D1, D3, and D5 indicates data in which the logical address area 60 of the second magnetic disk 10b (more accurately, the logical address area 60 on the second recording surface) is the final write destination.

When an outage of power supply to the magnetic disk device 1 is detected, the controller 30 writes the data D2 and D4 to the cache area 61 of the second magnetic disk 10b (more accurately, the cache area 61 on the second recording surface) by controlling the second actuator system 20b and the second magnetic head HDb. As discussed above, even if the logical address values associated with data D2 and D4 are not sequential, the controller 30 can write the data D2 and D4 to a continuous area in the cache area 61 of the second magnetic disk 10b. The controller 30 writes the data D1, D3, and D5 to the cache area 61 of the first magnetic disk 10a (more accurately, the cache area 61 on the first recording surface) by controlling the first actuator system 20a and the first magnetic head HDa. The controller 30 can write the data D1, D3, and D5 to a continuous area in the cache area 61 of the first magnetic disk 10a.

As described above, in the save operation, the controller 30 writes the data whose logical address area 60 on the first recording surface is the final write destination to the cache area 61 on the second recording surface, and writes the data whose logical address area 60 on the second recording surface is the final write destination to the cache area 61 on the first recording surface.

The controller 30 can independently execute access to the first recording surface and access to the second recording surface. Therefore, the controller 30 executes writing of the data D2 and D4 to the cache area 61 on the second recording surface and writing of the data D1, D3, and D5 to the cache area 61 on the first recording surface in parallel. In other words, the controller 30 executes each writing so that the period of writing the data D2 and D4 to the cache area 61 on the second recording surface and the period of writing the data D1, D3, and D5 to the cache area 61 on the first recording surface partially or wholly overlap. As a result, the time required for the save operation is further reduced. The period of writing the data D2, D4 to the cache area 61 of the second recording surface and the period of writing the data D1, D3, and D5 to the cache area 61 of the first recording surface do not necessarily have to overlap.

The power for implementing the save operation is acquired in any manner. In one example, the controller 30 can execute writing of the data D1 to D5 to the magnetic disk 10 by using the counter electromotive force generated by the spindle motor 11. Alternatively, the magnetic disk device 1 includes a capacitor that stores a part of the power when the power is supplied to the magnetic disk device 1, and can execute writing of the data D1 to D5 to the magnetic disk 10 by using the power stored in the capacitor. When the first event is that the acceleration value detected by the acceleration sensor 42 indicates the application of impact or vibration exceeding the permissible level, or that a flush command is received from the host 2, the controller 30 can execute writing of the data D1 to D5 to the magnetic disk 10 by using the power supplied from the power source 3.

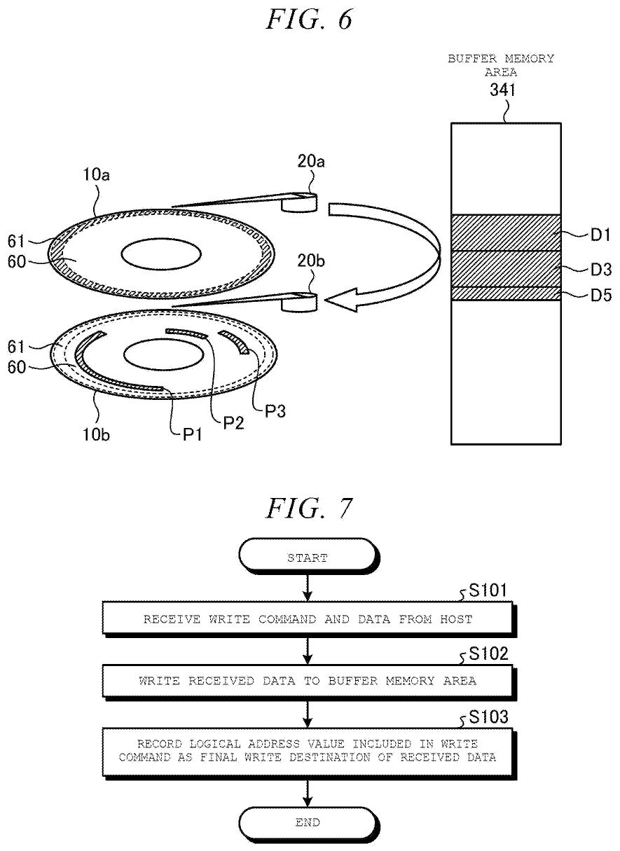

When the power supply to the magnetic disk device 1 is resumed, the controller 30 moves each data saved in the cache area 61 to the final write destination in the logical address area 60. FIG. 6 is a schematic diagram illustrating the operation of the embodiment in which the data saved in the media cache area 61 is moved to the logical address area 60. In this drawing, as an example, the flow of data D1, D3, and D5 is drawn.

The data whose final write destination is the logical address area 60 on the first recording surface (that is, the recording surface of the first magnetic disk 10a) is saved in the cache area 61 on the second recording surface (that is, the recording surface of the second magnetic disk 10b), and the data whose final write destination is the logical address area 60 on the second recording surface is saved in the cache area 61 on the first recording surface. Therefore, the controller 30 executes reading of data from the cache area 61 and writing of data to the logical address area 60 in parallel by using different actuator systems 20.

For example, regarding the data D1, D3, and D5, as illustrated in FIG. 6, the controller 30 reads data D1, D3, and D5 from the cache area 61 on the first recording surface by using the first actuator system 20a and the first magnetic head HDa. Further, before all reading of data D1, D3, and D5 from the cache area 61 on the first recording surface is completed, the controller 30 starts writing the read portion of the data D1, D3, and D5 to the final write destination in the logical address area 60 on the second recording surface by using the second actuator system 20b and the second magnetic head HDb.

The final write destination of each of the data D1, D3, and D5 is specified by a logical address value. That is, the final write destinations of the data D1, D3, and D5 in the logical address area 60 can be separated from each other. In the example illustrated in FIG. 6, the final write destination of the data D1 is a position P1, the final write destination of the data D3 is P2, and the final write destination of the data D5 is a position P3. The positions P1 to P3 are separated from each other. Therefore, when the data D1, D3, and D5 are written to the final write destination, the controller 30 executes seek control and tracking control for each of the data D1, D3, and D5.

Regarding the data D2 and D4 (not illustrated in FIG. 6), the controller 30 reads the data D2 and D4 from the cache area 61 on the second recording surface by using the second actuator system 20b and the second magnetic head HDb. Further, before all readings of data D2 and D4 from the cache area 61 on the second recording surface are completed, the controller 30 starts writing the read portion of the data D2 and D4 to the final write destination in the logical address area 60 on the first recording surface by using the first actuator system 20a and the first magnetic head HDa.

In this way, the controller 30 starts writing the portion read from the cache area 61 to the logical address area 60 before the reading of all the data from the cache area 61 is completed. That is, the controller 30 executes processing of reading data from the cache area 61 and writing the data to the buffer memory area 341 and processing of reading data from the buffer memory area 341 and writing the data to the logical address area 60 in parallel.

The technique to be compared with the embodiment will be described. The technique to be compared with the embodiment is referred to as a comparative example. In the comparative example, the data whose final write destination is the logical address area accessed by using a certain actuator system is saved in the logical address area accessed by using the actuator system. In such a case, when moving the data saved in the media cache area to the logical address area, the period for executing the processing of reading data from the media cache area and writing the data to the buffer memory area and the period for executing the processing of reading data from the buffer memory area and writing the data to the logical address area cannot be overlapped.

On the other hand, according to the embodiment, the period for executing the processing of reading data from the cache area 61 and writing the data to the buffer memory area 341 and the period for executing the processing of reading data from the buffer memory area 341 and writing the data to the logical address area 60 can be overlapped at least in part. Therefore, as compared with the comparative example, the time required for the operation of moving the data saved in the cache area 61 to the logical address area 60 is reduced.

FIG. 7 is a flowchart illustrating an example of the operation at the time of receiving data of the magnetic disk device 1 of the embodiment.

The magnetic disk device 1 receives a write command and data from the host 2 (S101). The data may be included in a command set of write commands, or may be transferred separately from the command set of write commands.

The controller 30 (for example, the hard disk controller 37) writes the received data to the buffer memory area 341 (S102). Further, the controller 30 (for example, the hard disk controller 37) acquires the logical address value from the write command and stores the acquired logical address value as the final write destination of the received data (S103). For example, in S103, the controller 30 records the logical address value in the management information described above. Then, the operation at the time of receiving the data ends.

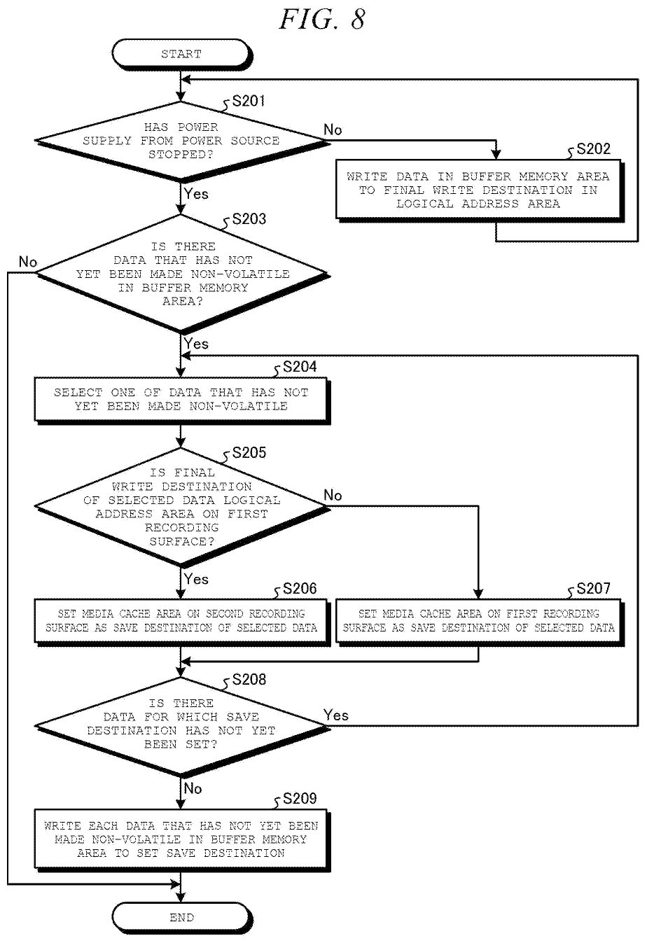

FIG. 8 is a flowchart illustrating an example of the operation of the magnetic disk device 1 of the embodiment in which the data in the buffer memory area 341 is written to the magnetic disk 10.

The power supply circuit 41 determines whether or not the power supply from the power source 3 has stopped (S201). When it is determined that the power supply from the power source 3 has not stopped (S201: No), the controller 30 writes the data in the buffer memory area 341 to the final write destination in the logical address area 60 by controlling the actuator system 20 and the magnetic head HD (S202). Then, the control transits to S201.

When it is determined that the power supply from the power source 3 has stopped (S201: Yes), the power supply circuit 41 transmits an interrupt signal to the processor 35. Upon receiving the interrupt signal, the processor 35 determines whether or not there is data that has not yet been made non-volatile in the buffer memory area 341 (S203). When it is determined that there is no data that has not yet been made non-volatile in the buffer memory area 341 (S203: No), the operation ends.

When it is determined that there is data that has not yet been made non-volatile in the buffer memory area 341 (S203: Yes), the processor 35 selects one of the data that has not yet been made non-volatile in the buffer memory area 341 (S204). Then, the processor 35 determines whether or not the final write destination of the selected data is the logical address area on the first recording surface, that is, the logical address area 60 that can be accessed by using the first actuator system 20a (S205).

The final write destination of the selected data can be determined, for example, by referring to management information. For example, when receiving a write command, the controller 30 writes the data requested to be written by the write command to the buffer memory area 341 (see, for example, S102 in FIG. 7). Further, the controller 30 acquires a logical address value from the write command as information indicating the final write destination of the data, and records the logical address value in association with the data in the management information (see, for example, S103 in FIG. 7). Therefore, in the management information, a list of logical address values for each data stored in the buffer memory area 341 is recorded. In S205, the processor 35 determines whether the logical address value associated with the selected data is included in the group of logical address values associated with the logical address area 60 on any of the first recording surfaces or included in the group of logical address values associated with the logical address area 60 on any second recording surface. When the logical address value associated with the selected data is included in the group of logical address values associated with the logical address area 60 on any of the first recording surfaces, it is determined that the final write destination of the selected data is the logical address area 60 on the first recording surface. When the logical address value associated with the selected data is included in the group of logical address values associated with the logical address area 60 on any of the second recording surfaces, it is determined that the final write destination of the selected data is not the logical address area 60 on the first recording surface, but the logical address area 60 on the second recording surface.

When the final write destination of the selected data is the logical address area 60 on the first recording surface (S205: Yes), the processor 35 sets the cache area 61 on the second recording surface as a save destination of the selected data (S206).

When the final write destination of the selected data is not the logical address area 60 on the first recording surface (S205: No), in other words, when the final write destination of the selected data is the logical address area 60 on the second recording surface, the processor 35 sets the cache area 61 on the first recording surface as a save destination for the selected data (S207).

After S206 or S207, the processor 35 determines whether or not there is data for which a save destination has not yet been set among the data that has not yet been made non-volatile in the buffer memory area 341 (S208). When it is determined that there is data for which a save destination has not been set yet (S208: Yes), the control transits to S204, and the processor 35 selects one data for which a save destination has not yet been set.

When it is determined that there is no data for which the save destination has not been set yet (S208: No), the controller 30 writes each data in the buffer memory area 341 that has not yet been made non-volatile to the set save destination by controlling the first actuator system 20a, the second actuator system 20b, the first magnetic head HDa, and the second magnetic head HDb (S209).

In S209, the controller 30 can execute writing of the data to the cache area 61 on the first recording surface by controlling the first actuator system 20a and the first magnetic head HDa, and in parallel, can execute writing of data to the cache area 61 on the second recording surface by controlling the second actuator system 20b and the second magnetic head HDb.

When S209 ends, the operation of the magnetic disk device 1 ends.

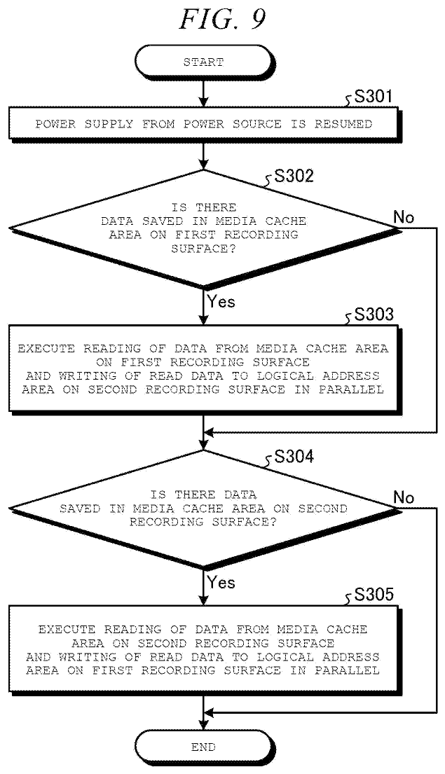

FIG. 9 is a flowchart illustrating an example of the operation of the magnetic disk device 1 when the power supply from the power source 3 is resumed. In this flowchart, the operations related to the movement of the saved data are mainly described, and the description of some processing including the start of rotation of the spindle motor 11 is omitted.

When the power supply from the power source 3 is resumed due to the power-on of the host 2 or the like (S301), the processor 35 determines whether or not there is data saved in the cache area 61 on the first recording surface (S302).

The specific processing of S302 is designed in any manner. In one example, during data saving, that is, during the processing of S209 in FIG. 8, a list of data saved in the cache area 61 on the first recording surface and the second recording surface is written to a non-volatile storage area, for example, a predetermined position of the magnetic disk 10. In addition to the position of the save destination, the final write destination of each data may be recorded in the list. The processor 35 can determine whether or not there is data saved in the cache area 61 on the first recording surface based on the list.

When it is determined that there is not saved data (S302: No), the operation when the power supply from the power source 3 is resumed ends.

When it is determined that there is data saved in the cache area 61 on the first recording surface (S302: Yes), the processor 35 executes reading of data from the cache area 61 on the first recording surface and writing of the read data to the final write destination of the logical address area 60 on the second recording surface in parallel (S303). The processing of S303 is executed for all the data saved in the cache area 61 on the first recording surface.

After S303, or when it is determined that there is no data saved in the cache area 61 on the first recording surface (S302: No), the processor 35 determines whether or not there is data saved in the cache area 61 on the second recording surface (S304). The specific processing of S304 is designed in any manner. In one example, the determination of S304 is executed in the same manner as S302.

When it is determined that there is data saved in the media cache area 61 on the second recording surface (S304: Yes), the controller 30 executes reading of the data from the cache area 61 on the second recording surface and writing of the read data to the logical address area 60 on the first recording surface in parallel (S305). The processing of S305 is executed for all the data saved in the cache area 61 on the second recording surface.

After S305, or when it is determined that there is no data saved in the cache area 61 on the second recording surface (S304: No), the operation when the power supply from the power source 3 is resumed ends.

The magnetic disk device 1 of the embodiment operates as follows, for example, by having the configuration described above. That is, when receiving data (indicated as first data) requested to be written by a write command including a logical address value (indicated as first logical address value) included in the group of the logical address values associated with the logical address area 60 on the first recording surface, the controller 30 writes the first data to the buffer memory area 341. Then, when the first event, for example, that an outage of the power supply from the power source 3 is detected after the first data is written to the buffer memory area 341, does not occur, the controller 30 writes the first data in the buffer memory area 341 to the position associated with the first logical address value in the logical address area 60 on the first recording surface by controlling the first actuator system 20a and the first magnetic head HDa. When the first event occurs from when the first data is written to the buffer memory area 341 to when the first data is written to the logical address area 60, the controller 30 writes the first data in the buffer memory area 341 to the cache area 61 on the second recording surface by controlling the second actuator system 20b and the second magnetic head HDb.

Therefore, when the first data is moved from the cache area 61 to the final write destination in the logical address area 60, the processing of reading the first data from the cache area 61 and the processing of writing the first data to the logical address area 60 can be executed in parallel. Therefore, it is possible to reduce the time required for data transfer via the cache area 61.

The controller 30 reads the first data from the cache area 61 by controlling the second actuator system 20b and the second magnetic head HDb. Further, the controller 30 writes the first data read from the cache area 61 to the logical address area 60 by controlling the first actuator system 20a and the first magnetic head HDa. The processing of reading the first data from the cache area 61 by controlling the second actuator system 20b and the second magnetic head HDb is an example of first processing. The processing of writing the first data read from the media cache area 61 to the logical address area 60 by controlling the first actuator system 20a and the first magnetic head HDa is an example of second processing.

Since the controller 30 executes the first processing and the second processing in parallel, the time required for data transfer via the cache area 61 can be reduced.

Further, according to the embodiment, when receiving the data (indicated as second data) requested to be written by a write command including a logical address value (indicated as second logical address value) included in the group of the logical address values associated with the logical address area 60 on the second recording surface, the controller 30 writes the second data to the buffer memory area 341. Then, when the first event, for example, that an outage of power supply from the power source 3 is detected after the second data is written to the buffer memory area 341, does not occur, the controller 30 writes the second data in the buffer memory area 341 to the position associated with the second logical address value in the logical address area 60 on the second recording surface by controlling the second actuator system 20b and the second magnetic head HDb. When the first event occurs from when the second data is written to the buffer memory area 341 to when the second data is written to the logical address area 60, the controller 30 writes the second data in the buffer memory area 341 to the cache area 61 on the first recording surface by controlling the first actuator system 20a and the first magnetic head HDa.

Therefore, when the second data is moved from the cache area 61 to the final write destination in the logical address area 60, the processing of reading the second data from the cache area 61 and the processing of writing the second data to the logical address area 60 can be executed in parallel. In this way, it is possible to reduce the time required for data transfer via the cache area 61.

The controller 30 reads the second data from the cache area 61 by controlling the first actuator system 20a and the first magnetic head HDa. Further, the controller 30 writes the second data read from the cache area 61 to the logical address area 60 by controlling the second actuator system 20b and the second magnetic head HDb. The processing of reading the second data from the cache area 61 by controlling the first actuator system 20a and the first magnetic head HDa is an example of third processing. The processing of writing the second data read from the cache area 61 to the logical address area 60 by controlling the second actuator system 20b and the second magnetic head HDb is an example of fourth processing.

Since the controller 30 executes the third processing and the fourth processing in parallel, the time required for data transfer via the cache area 61 can be reduced.

Further, according to the embodiment, when the first event occurs from when the first data and the second data are written to the buffer memory area 341 to when until at least one of writing the first data to the logical address area 60 on the first recording surface and writing the second data to the logical address area 60 on the second recording surface is executed, in other words, when the first event occurs while both the first data and the second data in the buffer memory area 341 have not yet been made non-volatile, the controller may execute processing of writing the first data in the buffer memory area 341 to the cache area 61 on the second recording surface by controlling the second actuator system 20b and the second magnetic head HDb and processing of writing the second data in the buffer memory area 341 to the cache area 61 on the first recording surface by controlling the first actuator system 20a and the first magnetic head HDa in parallel.

Therefore, the time required for the save operation is reduced. That is, the time required for data transfer via the cache area 61 can be further reduced.

The first event is, for example, that the power supply circuit 41 detects an outage of power supply to the magnetic disk device 1.

Therefore, it is possible to prevent the data in the buffer memory area 341 from being lost from the magnetic disk device 1 due to the power cut-off.

Alternatively, the first event may indicate the application of impact or vibration whose acceleration value detected by the acceleration sensor 42 exceeds the permissible level.

Therefore, it is possible to prevent the data in the buffer memory area 341 from being lost from the magnetic disk device 1 due to the impact or vibration applied to the magnetic disk device 1.

When the first event is that the acceleration value detected by the acceleration sensor 42 indicates the application of impact or vibration exceeding the permissible level, the movement of data from the cache area 61 to the logical address area 60 can be executed at any timing. For example, when the applied impact or vibration indicated by the acceleration value detected by the acceleration sensor 42 falls below the permissible level, the controller 30 may execute the movement of data from the cache area 61 to the logical address area 60.

Alternatively, the first event may be that a flush command is received from the host 2.

The magnetic disk device 1 saves the data in the buffer memory area 341 to the cache area 61 in response to the flush command, and then, for example, when the frequency of receiving commands from the host 2 decreases, moves the data saved in the cache area 61 to the logical address area 60. Since the time required for data transfer via the cache area 61 is reduced, the time required for processing in response to the flush command is reduced. Therefore, the ability to process the command of the magnetic disk device 1 as seen from the host 2 can be improved.

In the above description, the magnetic disk device 1 includes two actuator systems 20a and 20b that can be individually driven. The embodiment is also applicable to a magnetic disk device including three or more actuator systems that can be driven individually. In a magnetic disk device including three or more actuator systems that can be driven individually, when saving data whose final write destination is the logical address area on the recording surface accessed under the control of one of the three or more actuator systems, the controller writes the data to the media cache area on one or more recording surfaces accessed under the control of one or more other actuator systems. Then, when moving the data saved in the media cache area on the one or more recording surfaces to the final write destination, the controller executes reading of the data from the media cache area on the one or more recording surfaces and writing of the read data to the final write destination in parallel. This reduces the time required to transfer data via the media cache area.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A magnetic disk device configured to be operable in response to a first event, the magnetic disk device comprising:
a first magnetic disk comprising a first recording surface, the first recording surface comprising a first area associated with logical address values of a first group;
a second magnetic disk comprising a second recording surface, the second recording surface comprising a cache area and a second area, separate from the cache area, associated with logical address values of a second group;
a first magnetic head that performs data write and data read on the first recording surface, the first magnetic head being moved by a first actuator system;
a second magnetic head that performs data write and data read on the second recording surface, the second magnetic head being moved by a second actuator system;
a buffer memory; and
a controller configured to:
write, to the buffer memory, first data for which a first logical address value of the first group is specified, and
after the first data is written to the buffer memory, write the first data in the buffer memory to the cache area of the second magnetic disk in response to an occurrence of the first event.

2. The magnetic disk device according to claim 1, wherein, after the controller writes the first data to the cache area of the second magnetic disk,
the controller is further configured to execute first processing and second processing in parallel, wherein
the first processing comprises reading the first data from the cache area of the second magnetic disk, and
the second processing comprises writing the first data read from the cache area of the second magnetic disk to a position on the first area of the first recording surface that is associated with the first logical address value.

3. The magnetic disk device according to claim 1, wherein
the first magnetic disk further comprises a cache area and wherein
the controller is further configured to:
write, to the buffer memory, second data for which a second logical address value of the second group is specified,
after the second data is written to the buffer memory, write the second data in the buffer memory to the cache area of the first magnetic disk in response to the occurrence of the first event.

4. The magnetic disk device according to claim 3, wherein, after the controller writes the second data to the cache area of the first magnetic disk,
the controller is further configured to execute third processing and fourth processing in parallel, wherein
the third processing comprises reading the second data from the cache area of the first magnetic disk by controlling the first magnetic head and the first actuator system, and
the fourth processing comprises writing the second data read from the cache area of the first magnetic disk to a position on the second area of the second recording surface that is associated with the second logical address value.

5. The magnetic disk device according to claim 3, wherein
when the first event occurs from when the first data and the second data are written to the buffer memory to when at least one of writing the first data to the first area and writing the second data to the second area is executed, the controller is configured to execute processing of writing the first data in the buffer memory to the cache area of the second magnetic disk by controlling the second magnetic head and the second actuator system and processing of writing the second data in the buffer memory to the cache area of the first magnetic disk by controlling the first magnetic head and the first actuator system in parallel.

6. The magnetic disk device according to claim 1, further comprising:
a circuit that monitors power supplied to the magnetic disk device, and wherein the first event is that the circuit detects an outage of the power.

7. The magnetic disk device according to claim 1, further comprising:
a sensor that detects an impact, and wherein the first event is that the sensor detects the impact.

8. The magnetic disk device according claim 1, wherein the first event is that a flush command to write data in the buffer memory to the magnetic disk is received from the host.

9. A method of operating a magnetic disk device in response to a first event, the method comprising:
receiving, from a host, first data having a first specified logical address value associated with a first group of logical address values for a first area of a first recording surface on a first magnetic disk;
writing to a buffer memory the first data; and
in response to the first event, writing the first data in the buffer memory to a cache area associated with a second recording surface on a second magnetic disk, wherein the second recording surface further comprises a second area, separate from the cache area, associated with logical address values of a second group different from the first group.

10. The method of claim 9, wherein:
the writing and reading of data on the first recording surface is performed by a first magnetic head configured to be moved by a first actuator system; and wherein
the writing and reading of data on the second recording surface is performed by a second magnetic head configured to be moved by a second actuator system.

11. The method of claim 10, further comprising executing first processing and second processing in parallel, wherein
first processing comprises reading the first data from the cache area of the second magnetic disk, and
second processing comprises writing the first data read from the cache area of the second magnetic disk to a position on the first area of the first recording surface that is associated with the first logical address value.

12. The method of claim 11, further comprising
receiving, from the host, second data having a second specified logical address value associated with a second group of logical address values for the second area of the second recording surface of the second magnetic disk;
writing to the buffer memory the second data; and
in response to the first event, writing the second data in the buffer memory to a second cache area associated with the first recording surface of the first magnetic disk, wherein the second cache area is separate from the first area.

13. The method of claim 12, further comprising executing third processing and fourth processing in parallel, wherein
third processing comprises reading the second data from the cache area of the first magnetic disk, and
fourth processing comprises writing the second data read from the cache area of the first magnetic disk to a position on the second area of the second recording surface that is associated with the second logical address value.

14. The method of claim 13 further comprising,
when the first event occurs from when the first data and the second data are written to the buffer memory to when at least one of writing the first data to the first area and writing the second data to the second area is executed,
executing processing of writing the first data in the buffer memory to the cache area of the second magnetic disk by controlling the second magnetic head and the second actuator system and processing of writing the second data in the buffer memory to the cache area of the first magnetic disk by controlling the first magnetic head and the first actuator system in parallel.
